(19) United States
(12) Patent Application Publication
(10) Pub. No.: US 2006/0145495 A1
(43) Pub. Date: Jul. 6, 2006

(54) Finger device capable of grasping objects

(75) Inventors: Chih-Hsing Fang, Hsinchu City (TW); Wen-Nan Huang, Taipei City (TW); Chien-Wu Chen, Longjing Township (TW); Chih-Hsin Chen, Hsinchu City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Chutung (TW)

(21) Appl. No.: 11/313,675

(22) Filed: Dec. 22, 2005

(30) Foreign Application Priority Data
Dec. 31, 2004 (TW) 093141769

(51) Int. Cl. B25J 15/08

(52) U.S. Cl. 294/106

(57) ABSTRACT

A finger device for grasping objects is disclosed, which comprises multiple base members and a driving belt. Each base member comprises a main body, a first axle defined in the main body, a second axle defined in the main body, an elastic member and a binding member. The binding member is used for connecting the neighboring main bodies for continuous motion. The elastic member also connects the neighboring main bodies for changing or recovering the relative positions of the main bodies. The first axle and the second axle of one base member are located along a different line from the first axle of another base member, and the driving belt is used for connecting to the first axle and the second axle of each base member. Therefore, as the driving belt is pulled, the relative positions of the main bodies change and the finger device bends.

### BACKGROUND OF THE INVENTION

1. Field of the Invention

The present invention relates to a finger device that is capable of grasping objects, and more particularly, to a grasping finger device that can be applied in a robotic arm.

2. Description of the Related Art

With the average age in society increasing, the population of the elderly is growing, and most of these seniors prefer to live in their own home instead of moving into a nursing home for specialized geriatric care. As a result, home care for the elderly is a growth market, and includes such products as home medical equipment, remote monitoring devices, and personnel for assisted-living residents.

Recently, certain companies have developed intelligent robots for assisting the elderly with daily living so as to reduce nursing costs. These robots can help seniors to grasp objects (like glasses), and utilizes sensors (such as an infrared temperature sensor) to monitor the health of the patient. When the sensors detect unusual conditions, such as a fever or high blood pressure, these intelligent robots are capable of automatically calling for help to inform a nurse or family member of the problem.

However, as shown in FIG. 1, a prior art finger device 11 on the intelligent robot for grasping objects has very complex structure and every movable member (such as a first finger member 12 and a second finger member 13 shown in FIG. 1) needs a driving device 14, a connection cable 15 and a controller 16, so every finger member has its own relative position. Therefore, the prior art finger device for grasping objects 11 is not suitable for use in a confined space, futhermore, the typical finger device 11 on the intelligent robot only has two finger members which cannot provide a strong holding force. Therefore, this typical finger device 11 on the intelligent robot is also not suitable for grasping objects of different shapes and sizes. Therefore, it is desirable to provide a finger device for grasping objects to mitigate and/or obviate the aforementioned problems.

### SUMMARY OF THE INVENTION

A finger device for grasping objects according to the present invention comprises multiple base members, and a driving belt. Each base member includes a main body, a first axle defined in the main body, a second axle defined in the main body, an elastic member and a binding member. The binding member is used for connecting the neighboring main bodies for continuous motion. Moreover, the first axle and the second axle of one base member are located along a different line from the first axle of another base member. Thus, the positions of the projections of the first axle and the second axle of one base member and that of the first axle of another base member on the same side surface of the main body are not located on the same straight line. The elastic member also connects the neighboring main bodies for changing or restoring the relative positions of the main bodies. The driving belt is used for connecting to the first axle and the second axle of each base member to form a resulting force to change the relative positions of the main bodies. Therefore, as the driving belt is pulled, the resulting force changes the relative positions of the main bodies to bend the finger device.

As indicated in the above description, the finger device for grasping objects according to the present invention controls the driving direction of an electrical motor to change the length of the driving belt, and utilizes springs to change a bent condition of the finger device. Consequently, the finger device for grasping objects according to the present invention has a simple structure, few elements, and a small size. Furthermore, the finger device can have different numbers of base members to form a human hand-like device to grab different objects. Finally, the finger device can be applied to other mechanical devices (such as robotic arms) to grasp and move objects.

Moreover, a mechanical grasping device composed of the finger device of the present invention can be used for various situations, such as (1) for exchanging fuel rods in nuclear power plants to avoid radiation exposure of operators, and (2) assisting the elderly to grasp various objects.

The finger device for grasping objects according to the present invention may utilize different driving devices, such as electrical motors or stepping motors. The finger device of the present invention may further utilize different sensing devices, such as pressure sensors, humidity sensors or temperature sensors. The sensing device of the finger device can be located at any position, and specifically may be located at the end of the finger device. The finger device may have various numbers of base members, such as two, three, or four. The base member of the finger device of the present invention may be a casing with any shape, such as a hollow casing or a solid casing. The finger device of the present invention can have different types of elastic members, such as elastic belts or springs. The finger device of the present invention can have different types of binding members, such as pivots. The finger device of the present invention can have different types of first axes, such as a static shaft having grooves or a roller. The finger device of the present invention can have different types of second axes, such as a static shaft having grooves or a roller. The finger device of the present invention can utilize different materials for the driving belt, such as elastic cables.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art finger device for grasping objects.

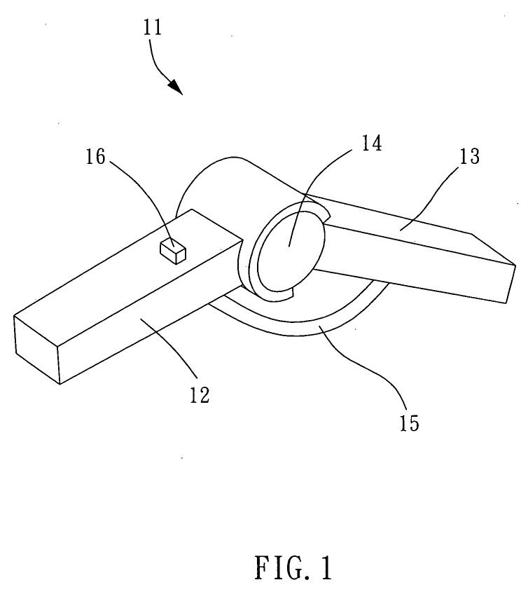

FIG. 2A is a schematic drawing in cross section of a finger device in an initial state for grasping objects in an embodiment according to the present invention.

FIG. 2B is a schematic drawing in cross section of a finger device in a bent state for grasping objects in an embodiment according to the present invention.

FIG. 3 is a perspective view of a finger device in a bent state for grasping objects in another embodiment according to the present invention.

FIG. 4 is a schematic drawing of a plurality of finger devices applied to a front end of a robotic hand for grasping an object.

### DETAILED DESCRIPTION OF THE PREFERRED EMBODIMENT

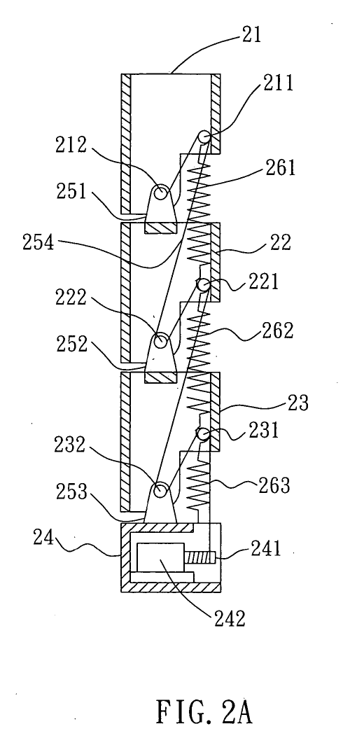

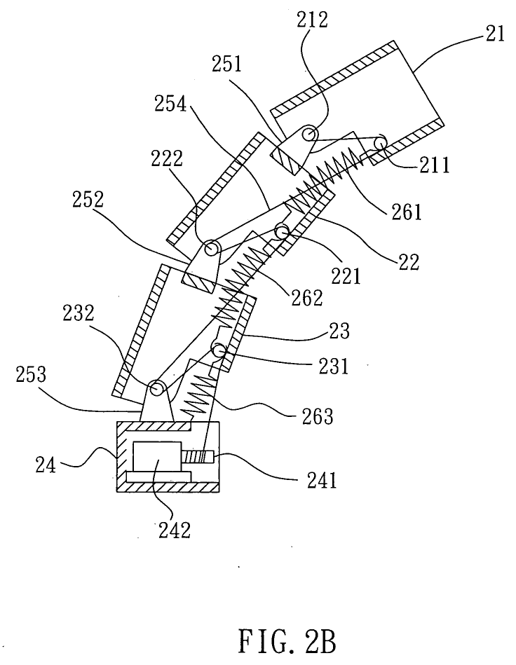

FIG. 2A is a schematic drawing of a finger device in an initial status for grasping an object in an embodiment according to the present invention. The finger device comprises a base member 21, a base member 22, a base member 23 and a driving device 24, which are all connected respectively by a first shaft 251, a second shaft 252 and a third shaft 253. A driving belt 254 separately connects to a first axle 211 and a second axle 212 of the base member 21, a first axle 221 and a second axle 222 of the base member 22, and a first axle 231 and a second axle 232 of the base member 23. Besides, one end of the driving belt 254 is secured to a shaft 241 of the driving device 24. A first spring 261 is placed between the base member 21 and the base member 22; a second spring 262 is placed between the base member 22 and the base member 23, and a third spring 263 is placed between the base member 23 and the driving device 24. As a result, when the finger device of the present invention forms a specific bent shape (as shown in FIG. 2B), the springs can work with the driving belt 254 to increase the length of the finger device respective to the original status.

When the finger device for grasping object needs to form a specific bent shape, an electric motor 242 in the driving device 24 rotates the shaft 241 so that the driving belt 254 among the base member 21, the base member 22, the base member 23 becomes shorter and shorter. Meanwhile, the relative positions of the first base member 21, the second base member 22 and the third base member 23 change till the finger device forms the specific bent shape, as shown in FIG. 2B.

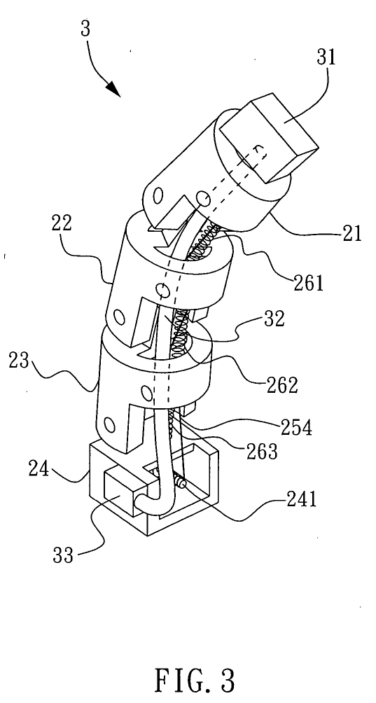

As shown in FIG. 3, in another embodiment, the finger device 3 for grasping has a pressure sensor 31 on its distal tip for sensing pressure applied from the finger device 3 to an object. A sensing signal generated by the pressure sensor 31 is sent to a controller 33 in the driving device 24 via a sensing cable 32. The controller 33 follows a preset rule to control operations (clockwise or counter-clockwise) of the electrical motor 242 of the driving device 24 according to the sensing signal, so the finger device for grasping objects can be in a predetermined state.

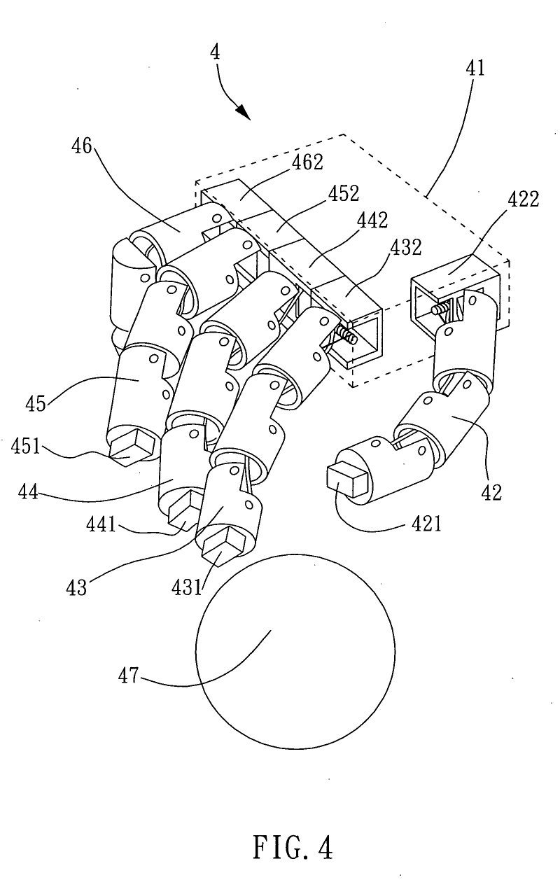

FIG. 4 is a schematic drawing of the finger device applied at a front end of a robotic hand for grasping an object. The robotic hand 4 includes a palm member 41, a first finger member 42, a second finger member 43, a third finger member 44, a fourth finger member 45, and a fifth finger member 46. Furthermore, all the finger members and palm member compose the finger device for grasping objects of the present invention, and each finger device can combine different numbers of base members to form finger devices for grasping objects with different lengths, like human fingers.

When the robot hand grasps a ball 47, as shown in FIG. 4, individual driving devices on the first finger member 432, the second finger member 43, the third finger member 44, the fourth finger member 45, and the fifth finger member 46 change their bent state according to a preset rule. When the sensing device 421 at the end of the first finger member 42 touches the surface of the ball 47, a first sensing device 421 sends out a sensing signal to a controller (not shown in the drawing) of a first driving device 422 to control movement of the first finger member 42, and to control the pressure applied to the ball 47. Similarly, the other finger members (the second finger member 43, the third finger member 44, the fourth finger member 45, and the fifth finger member 46) can control their respective driving devices (a second driving device 432, a third driving device 432, a fourth driving device 432, and a fifth driving device 432) according to sensing signals sent by their respective sensing devices (a second sensing device 431, a third sensing device 441, a fourth sensing device 451, and a fifth sensing device 46 1), and adjust the positions of each finger member and pressure applied to the ball 47. (Due to the viewing angle, the sensing device on the fifth finger member 46 cannot be seen in FIG. 4).

When every finger members touches and applies proper pressure to the ball 47, the robotic hand 4 can grasp the ball 47. The robotic hand can then move the ball 47 according to the movement of the robotic arm.

Although the present invention has been explained in relation to its preferred embodiment, it is to be understood that many other possible modifications and variations can be made without departing from the spirit and scope of the invention as hereinafter claimed.

What is claimed is:

1. A finger device for grasping an object, the finger device comprising:
a plurality of base members comprising:
a main body;
a first axle;
a second axle;
an elastic member; and
a binding member; and
a driving belt;
wherein the first axle and the second axle of one base member are located along a different line from the first axle of another base member, and the driving belt is used for connecting to the first axle and the second axle of each base member to form a resulting force to change the relative positions of the main bodies, the elastic member connecting the main body and the neighboring main bodies for changing or restoring relative positions of the main bodies by an elastic force, and the binding member used for connecting the main body and the neighboring main bodies.

2. The finger device as claimed in claim 1 further comprising a driving member connected to the driving belt to provide a pulling force on the driving belt.

3. The finger device as claimed in claim 2, wherein the driving member is an electric motor.

4. The finger device as claimed in claim 2 further comprising a sensing member and a signal cable, wherein the sensing member is located on a surface of the main body, the signal cable is separately connected to the sensing member and the driving member and used for transferring a sensing signal from the sensing member to the driving member to control the pulling force provided from the driving member to the driving belt.

5. The finger device as claimed in claim 1, wherein the sensing member is a pressure sensor, humidity sensor or a temperature sensor.

6. The finger device as claimed in claim 1, wherein the main body is a casing.

7. The finger device as claimed in claim 1, wherein the main body is a solid body.

8. The finger device as claimed in claim 1, wherein the elastic member is an elastic strip.

9. The finger device as claimed in claim 1, wherein the elastic member is a spring.

10. The finger device as claimed in claim 1, wherein the binding member further comprises an aperture and a rotating axle, and the rotating axle is defined in the aperture.

11. The finger device as claimed in claim 8, wherein the binding member is a pivot.

12. The finger device as claimed in claim 1, wherein the first axle and the second axle are both having grooves to engage the driving belt.

13. The finger device as claimed in claim 1, wherein the first axle and the second axle are both rollers.

14. The finger device as claimed in claim 2, wherein the driving member is a shaft having grooves to engage the driving belt.

15. The finger device as claimed in claim 1, wherein the first axle is the binding member.

16. The finger device as claimed in claim 1, wherein the driving belt is an elastic belt.
